(19) United States
(12) Patent Application Publication
(10) Pub. No.: US 2008/0131633 A1
(43) Pub. Date: Jun. 5, 2008

(54) Ceramic lever

(76) Inventor: Igor Grigorovich Gumennyy, Kharkov (UA)

Correspondence Address: BEEM PATENT LAW FIRM, 53 W. JACKSON BLVD., SUITE 1352, CHICAGO, IL, 60604-3787, US

(21) Appl. No.: 11/943,347

(22) Filed: Nov. 20, 2007

(30) Foreign Application Priority Data
Nov. 30, 2006 (UA) U 200612623

(51) Int. Cl. B32B 1/08

(52) U.S. Cl. 428/34.7

(57) ABSTRACT

A ceramic lever refers to ceramic articles used in food industry. Ceramic devices are used in many food applications both for manufacture of ceramic containers and miscellaneous appliances.

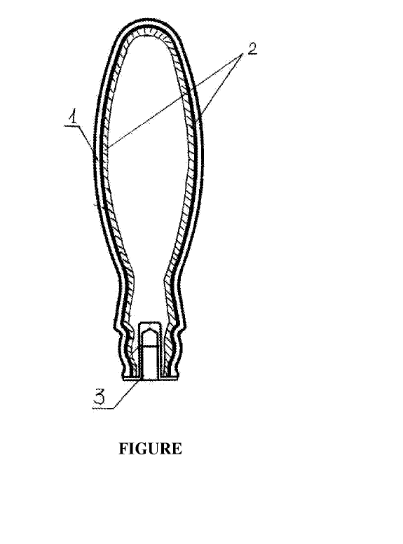

The proposed device is a lever made of ceramic material; ceramics is brittle, thus, in the course of lever operation it may undergo external mechanical forces, such as sudden impact, that generally cause cracks and spalling. After such mechanical damage large or small ceramic pieces may separate from the ceramic support and either get to beer or hurt operator's hand.

Therefore, the solution may be a ceramic lever comprising a hollow support with a glue coating applied to cavity internal walls wherein the glue coating is made from one of a series of thermoplastic glue melts and forms a layer between about 0.5 mm and about 3 mm thick.

This application claims the benefit of priority from Ukrainian patent application number u200612623, filed Nov. 30, 2006.

### BACKGROUND OF THE INVENTION

1. Field of the Invention

The present utility relates to ceramic devices used in food industry.

2. Description of the Related Art

Ceramic devices are used in many food applications both for manufacture of ceramic containers and miscellaneous appliances. The solution is the design of a ceramic lever used in dispensers of beverages, such as beer. The problem to be solved lies in strengthening of lever ceramic support in order to reduce its brittleness and to improve labor safety during operation.

Beer dispenser comprises a special mechanic system for comfortable feed of fluid as well as for its temporary storage. Beer is generally fed through a special mechanical tap, which comprises a valve and a small levering fixture. The levering fixture, or lever, serves to open and close such tap. Tap lever may be made from various food-compatible materials.

### BRIEF DESCRIPTION OF THE FIGURE

FIGURE is a cross-section of a ceramic lever.

### DETAILED DESCRIPTION

The proposed device is a lever made of ceramic material; ceramics is brittle, thus, in the course of lever operation it may undergo external mechanical forces, such as sudden impact, that generally cause cracks and spalling. After such mechanical damage large or small ceramic pieces may separate from the ceramic support and either get to beer or hurt operator's hand.

The described device may be strengthened, for instance, with an additional layer of laminated film, patent of Russian Federation number 2290313 of Dec. 27, 2006 “Film laminates, methods and devices for their production”, wherein a flexible laminate of thermoplastic polymer film comprises one corrugated layer and another flat layer connected thereto in contacting apices. The distance between corrugations is preferably equal or less than 3 mm. The thickness is substantially equal in both unconnected and connected areas. The corrugated layer comprises slackened areas coming parallel to corrugations, each connection area being substantially in the middle of the first slackened area. The method of laminate manufacture envisages a knurled shaft. Laminate formation device comprises joined knurled corrugating rolls and knurled laminating shaft. Corrugations may be filled with filler materials. One or both layers may be perforated after lamination. The result is increased strength of articled made of such materials and more comfortable operation.

Still, the surface of ceramic lever is glazed. So, such laminated films may be applied only to external surface of articles. As the outline of the proposed device is a complicated curve, this additional layer for strengthening of the ceramic layer would deteriorate lever appearance, and after some time of operation food residues begin to accumulate at certain places between the applied film and ceramic support. Thus, we suppose that outline strengthening according to described option would not be feasible.

Therefore, we propose to apply a special glue made of some thermoplastic glue melts and applied to internal surface of ceramic lever cavity, in order to strengthen articles of this kind. Glue melts creating a special coating on the internal surface of ceramic layer have a synthetic rubber basis. The glue melt as per Ukrainian Technical Specification TY Y 24.6-31610030-008:2005 comprises a synthetic rubber, rosin, vaseline oil, wax. Melted glues are known to have a good adhesion to metals, plastics, ceramics, wood, leather, fabrics, etc. Glue connections resist mechanical loads (including stripping and impact), as well as fuels, motor oils, fungi. Thermal resistance of most glue connections lies within the range between about 80° C. and about 100° C., in some cases even between about 125° C. and about 150° C. Glue melts are used in manufacture of machinery and instrumentation, containers and packing, as well as in printing and wood processing. Application of glue melts to strengthen surfaces of various materials has been widely known. For instance, the first industry to use glue melts and other glues was radio engineering. Components of ceramics and other materials in radio engineering are often strengthened just with such glues.

For instance, “Ceramic Resistive Element and Method of its Manufacture” are known from patent of Russian Federation number 2211496 of Aug. 27, 2003. It refers to electric and radio engineering and may be used for manufacture of wire resistors in automotive industry. Ceramic resistive element is a monolytic metal connection in ceramics obtained by joint high temperature firing without cracking of ceramics. Resistor metal with welded current outlets is a basic support having two layers of ceramic insulation. The first layer is a coating of composite material on the basis of ceramics and/or glass, and/or glass cement, and/or inorganic glue/cement. The second layer has the form of ceramic body defining the dimensions and external configuration of the article. Another embodiment of this invention supposes the second layer in the form of a metal container having a metal basic support within coated with ceramics and/or glass, and/or glass cement, and/or inorganic glue/cement, whose thickness and configuration lie within the scope of metal container cavity. The method of its manufacture consists in formation of the second ceramic layer by, say, hot die-casting. After application of the first layer and subsequent drying the article is heated and simultaneously wetted in a thermoplastic compound melt consisting of the same components that the thermoplastic slip of the second layer. Then the layers are co-treated under temperature in excess of that necessary for complete burnout of binder, whereas the complete sintering of ceramics is not necessary. The result is efficient heat transfer from the resistor, high thermal and electric safety in operation and cheap manufacture.

Besides, “Method of Decorative Paper Impregnation” are known from patent of Russian Federation number 2226578 of Apr. 10, 2004. Here in manufacture of decorative paper used in wear-resistant multi-layer floor coating, the paper is first wetted by impregnation with an amino resin, regulating the amount of resin with dosing rolls, then they spray on the wetted paper a layer of amino acid in an abrasive-containing dispersion. Before spraying the dispersion is constantly circulated to prevent sedimentation of the abrasive matter. The dispersion comprises an amino resin, an abrasive matter, silane glue, a flowability agent, wetting means, separating means and amine curing agent. The abrasive matter is silicon carbide or alumina in the form of corundum or a melt with particle size between about 60 and about 160 μm. The result consists in increased wear resistance of decorative multi-layer floor coating.

In spite of the fact that in this process the material to be strengthened is not brittle, we suppose that here a material of scarce strength (paper) was strengthened by application of thermoplastic glue melt layer.

In the same way metal plastic strips are strengthened according to patent of Russian Federation number 2290314 of Dec. 27, 2006 “Process and Apparatus for Metal Plastic Strip Manufacture”. This process comprises stages of cleaning, chemical pretreatment of cleaned metal strip, drying of metal strip and joint feeding of metal and plastic strips to pressure rolls. The means for metal strip cleaning and formation of a single non-metal chemical coating is perchloroethylene, the metal strip being dipped into its solution. Then the strip is heated to 35° C. Gluing primer is applied onto upper side of metal strip as a binder. After that the metal strip is heated to 50° C. before connecting to plastic strip which is coated from connection side with polyurethane glue melt heated up to its melting point. To improve adhesion before connected metal and plastic strips the plastic strip has larger width than the metal one. After connection plastic strip is cut to become equal in width to metal strip. The apparatus for this process is also described. The invention permits to obtain metal plastic strips capable of resisting hard formation of pipes with an internal seam without separation of polymer coating due to improved connection between metal and plastic strips, whereas the process and equipment are simplified.

The closest to the solution submitted herein is US application 20050139619 of Jun. 30, 2005 whose applicant proposes a beverage dispensing lever made of porcelain or ceramics that is preliminarily filled with foam, preferably of expanded polyurethane, which after curing reproduces the outline of lever inside this lever, thus strengthening lever body from within and serving as an accumulator for small pieces of lever body material.

Foamed polyurethane is known to be thermo insulating and as a kind of foam plastic may be both rigid and elastic. In solving a similar problem the above applicant proposes use of a material not compatible to foods. As our device is predestined for beer dispensers, the application of such materials may hamper customers' health. Beer is known to be in a state of uncompleted chemical reaction—the process of alcoholic fermentation of barley malt wort, thus foamed polyurethane would operate in an active medium. The US application 20050139619 never refers to any research substantiating application of foamed polyurethane-based materials interacting with food products. We suppose the application of foamed polyurethane and similar materials would be not only harmful, but also dangerous for the health of customers. Medical supervisory bodies must permit such usage.

Therefore, the solution has as its object to improve a ceramic lever comprising a hollow ceramic body with glue coating applied to internal walls of its cavity wherein glue coating is made of a series of thermoplastic glue melts and forms a layer between about 0.5 and about 3 mm thick.

The glue coating in the proposed solution is made of a series of synthetic rubber-based thermoplastic glue melts. As the lever internal surface is porous, due to adhesion of glue melt film to internal porous surface of ceramic lever the strength of glue connection increases. Thus, the strength of glue connection depends on adhesion of glue melt to the internal surface of coating. In our case this means adhesion to lever internal surface as well as cohesion of glue film and the properties of material, here ceramics.

Wetting of a surface with glue due to pouring of liquid glue to ceramic lever cavity is known to ensure maximum surface area of gluing. No special treatment of internal surface (mechanical cleaning, degreasing, roughing, etc.) is necessary. The glue coating is formed by way of glue layer cooling to a temperature under melting point of its basic components. As the melting point of glue film is sufficiently high and may never be reached under normal ceramic lever operation, we suppose that the submitted solution is quite acceptable for operation in dispensers of liquids, such as beer.

The device comprises: ceramic support 1, glue coating 2.

The device operates as follows.

Ceramic lever comprising ceramic support (1) and glue coating (2) is installed on tap (3), as shown in the FIGURE. Mechanical effects causing destruction of the ceramic support lead to appearance of cracks or spalling. Due to the circumstance that the internal cavity of ceramic lever is coated with a special glue made of a series of thermoplastic glue melts and applied to the internal surface of ceramic lever cavity, small or large chips of ceramic support remain within the initial outline of ceramic lever and never get out of there without additional act, such as being brushed by hand. Thus, the availability of glue coating wherein the chips of ceramic support stick leads to strengthening of lever ceramic form and prevents ceramic particles from getting to beer as well as accidental hurt of operator.

As seen from the above description, the proposed solution is new and applicable in industry. Ceramic lever strengthening with a thermoplastic glue melt would increase service life of the proposed device as well as ensures manufacture of more complicated and refined designs.

What is claimed is:

1. A ceramic lever comprising a hollow support with a glue coating applied to cavity internal walls characterized in that the glue coating is made from one of a series of thermoplastic glue melts and forms a strengthening layer between about 0.5 and about 3 mm thick.
